(19) United States
(12) Patent Application Publication
(10) Pub. No.: US 2024/0318925 A1
(43) Pub. Date: Sep. 26, 2024

(54) REACTOR FIN INSERT DESIGN

(71) Applicants: Lawrence Livermore National Security, LLC, Livermore, CA (US); OxEon ENERGY, LLC, North Salt Lake, UT (US)

(72) Inventors: Jorge Luis Barrera Cruz, Livermore, CA (US); Victor Alfred Beck, Livermore, CA (US); Joseph Jay Hartvigsen, North Salt Lake, UT (US)

(21) Appl. No.: 18/691,429

(22) PCT Filed: Jun. 7, 2022
(86) PCT No.: PCT/US2022/032565

§ 371 Date: Mar. 12, 2024

Related U.S. Application Data
(60) Provisional application No. 63/249,995, filed on Sep. 29, 2021.

(51) Int. Cl. F28F 1/40; B01J 19/00; B01J 19/24

(52) U.S. Cl. CPC F28F 1/40; B01J 19/0013; B01J 19/2485; B01J 2219/2412; B01J 2219/2432

(57) ABSTRACT

A heat conducting insert for a reactor includes an elongated center portion, a cross member extending outwardly from the center portion and an outer portion extending laterally from a distal end of the cross member. A reactor includes a shell and an insert in the shell. The insert includes an elongated center portion, a cross member extending outwardly from the center portion, and an outer portion extending laterally from a distal end of the cross member.

This invention was made with Government support under Contract No. DE-AC52-07NA27344 awarded by the United States Department of Energy. The Government has certain rights in the invention.

### FIELD OF THE INVENTION

The present invention relates to thermal control in flow reactors, and more particularly, this invention relates to fin insert designs for flow reactors.

### BACKGROUND

Most oil wells co-produce methane and natural gas liquids. These resources are typically flared, owing to the economic and logistical challenges of processing and transporting the gas to market. Intentional flaring of gas is a recognized environmental threat, and some countries are already enforcing prohibitions on flaring associated gas. Furthermore, minimizing the emission of greenhouse gases, and particularly carbon dioxide, is critical to reaching some climate targets and avoiding the gravest impacts from global warming. Many of these efforts are centered around decarbonization via electrification with carbon-free renewable energy sources such as solar, wind, etc. While this has led to significant reductions in CO₂ emissions, several challenges remain. The intermittency of renewable energy sources requires economically viable, large-scale energy storage technologies to aid with load balancing and to ensure electric grid stability. Additionally, there are still industrial sectors such as shipping and aviation which are significant sources of CO₂ emissions, but which are not easily coupled to electrical energy. Chemical manufacturing is especially challenging, as carbonaceous materials are a principal feedstock.

Liquid fuels and feedstocks are currently indispensable components of the global economy. Their sustainable production from atmospheric CO₂ through carbon recycling technologies would augment decarbonization efforts and further reduce emissions. Storing electrical energy in the form of liquid fuels would enable integration of difficult-to-decarbonize sectors with renewables while simultaneously addressing long term storage needs.

Fischer-Tropsch (FT) processes include a collection of chemical reactions which convert mixtures of carbon monoxide, hydrogen, and/or water into liquid hydrocarbons in the presence of metal catalysts. These reactions generally occur at temperatures in a range of about 150° C. to about 300° C. (e.g., about 302° F. to about 572° F.) and at pressures of one to several tens of atmospheres. In the conventional implementations, carbon monoxide and hydrogen, the feedstocks for Fischer-Tropsch processes, are produced from coal, natural gas, biomass, etc., in a process known as gasification. The Fischer-Tropsch process typically converts these gases into a synthetic lubrication oil and synthetic fuel.

The Fischer-Tropsch process provides an opportunity to convert this associated gas to high value liquid hydrocarbon fuels, which are storable and transportable. The FT reactor can also produce liquid fuels from renewable electric power whereby hydrogen (or syngas from carbon dioxide and steam) is produced by electrolysis rather than directly from waste fossil fuels. Thus, efforts to improve performance of FT reactors can potentially help mitigating climate change by reducing toxic waste and accelerate the adoption of renewable power alternatives by creating more efficient designs.

Fuel synthesis by the FT reaction is highly exothermic and the reaction rate increases exponentially with temperature. To prevent autothermal runaway, fixed-bed FT reactors use a large number of small diameter catalyst-containing tubes for reaction temperature control. The number of tubes required for a given production rate is inversely proportional to the tube diameter squared, while the reactor cost is proportional to the number of tubes. The design requirement for reactors to be built using many small catalyst tubes makes the capacity-specific cost of FT reactors so high that considerably large plants are required to achieve economies of scale.

### SUMMARY

A heat conducting insert for a reactor, according to one aspect, includes an elongated center portion, a cross member extending outwardly from the center portion and an outer portion extending laterally from a distal end of the cross member.

A reactor, according to another aspect, includes a shell and an insert in the shell. The insert includes an elongated center portion, a cross member extending outwardly from the center portion, and an outer portion extending laterally from a distal end of the cross member.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1A is an optimized design of one-half of a fin, in accordance with one aspect of the present disclosure.

FIG. 1B depicts an optimized design including the fin shown in FIG. 1A, in accordance with one aspect of the present disclosure.

FIG. 2A is an optimized design of one-half of a fin, in accordance with one aspect of the present disclosure.

FIG. 2B depicts an optimized design including the fin shown in FIG. 2A, in accordance with one aspect of the present disclosure.

FIG. 2C depicts a three-dimensional optimized design including the fin shown in FIG. 2A, in accordance with one aspect of the present disclosure.

FIG. 3 includes a representation of a problem domain separating the design subdomain and non-design subdomain, in accordance with one aspect of the present disclosure.

FIG. 4 is a table of bulk material properties, in accordance with one aspect of the present disclosure.

FIG. 5 is a table of optimization problem formulation parameters, in accordance with one aspect of the present disclosure.

FIG. 6 is a table of geometric and temperature constraints, in accordance with one aspect of the present disclosure.

FIG. 7 includes charts depicting performance of optimal designs, in accordance with one aspect of the present disclosure.

FIG. 8 includes reactor optimal designs for each prescribed temperature, in accordance with one aspect of the present disclosure.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred fin insert designs for flow reactors such as Fischer-Tropsch reactors, in accordance with various aspects of the present invention.

In one general approach, a heat conducting insert for a reactor includes an elongated center portion, a cross member extending outwardly from the center portion and an outer portion extending laterally from a distal end of the cross member.

In another general approach, a reactor includes a shell and an insert in the shell. The insert includes an elongated center portion, a cross member extending outwardly from the center portion, and an outer portion extending laterally from a distal end of the cross member.

Recent efforts in mitigating climate change have accelerated the development of new technologies for a safer and more sustainable future. Fischer-Tropsch (FT) reactors contribute to this goal by producing high-value liquid hydrocarbon fuels from energy that is currently wasted in most oil wells. Furthermore, Fischer-Tropsch reactors reduce CO2 emissions and flaring of coproduced methane. There remains a desire to improve the design of Fischer-Tropsch reactors for enabling energy savings in manufacturing and energy conversion processes through the implementation of modular, transportable systems.

Fischer-Tropsch processes involve a series of chemical reactions that produce a variety of hydrocarbons. Hydrocarbons, according to various aspects of the present disclosure, may include any compound of hydrogen and carbon. Exemplary hydrocarbons include methane, ethane, propane, butane, pentane, hexane, etc. Hydrocarbons may include any alkanes, alkenes, alkynes, aromatic hydrocarbons, etc., or any combination thereof, as would become apparent to one having ordinary skill in the art upon reading the present disclosure.

The produced hydrocarbons may be synthetic fuel in the form of a readily transportable and relatively stable energy storage medium. In exemplary processes, the resulting synthetic fuel is a mixture of hydrocarbons. In preferred aspects, the resulting synthetic fuel primarily comprises n-paraffins of C5 to C40 in length. A two-part product collection step of the mixture may include condensing the longer hydrocarbon chains at a higher temperature and separating the longer hydrocarbon chains from relatively shorter chains and any produced water.

The relatively longer hydrocarbon chains (e.g., hydrocarbon chains of length C20 to C40) form a solid at room temperature (e.g., FT paraffin wax). The relatively shorter hydrocarbon chains (e.g., hydrocarbon chains of length C5 to C20) form a liquid at room temperature (e.g., FT oil). Due to the stoichiometry of the reaction, a byproduct of water, approximately two-parts water to one-part fuel by weight, is also produced from the process and is separated out. For preferential production of wax or oil, operating conditions of the FT reactor can be optimized to promote shorter or longer hydrocarbon chain growth, in a manner which would be determinable by one having ordinary skill in the art.

Historically, FT technology has been focused on large scale, fixed-site plants. As presented herein, smaller-scale, transportable solutions are optimally designed to help capture distributed resources. Various aspects of the present disclosure improve upon the performance of flow reactors such as tubular Fischer-Tropsch reactors and similar systems characterized by thermo-catalytic reactions. At least some of the aspects described herein may be used with thermo-catalytic reactors of many different types, as would become apparent to one having ordinary skill in the art upon reading the present disclosure. In other approaches, at least some aspects as described herein may be used with other porous reactors where heat management is an important consideration. Fischer-Tropsch reactors are an exemplary implementation of the disclosed concepts, and the present disclosure should not be deemed to be limited thereto, unless otherwise noted herein.

For example, reactor designs implementing at least some of the aspects described herein may refer to the spatial arrangement of fin inserts encompassing a catalyst matrix encased in a tubular pipe. The performance of tubular Fischer-Tropsch reactors and similar systems characterized by thermo-catalytic reactions may be improved by designing appropriate layouts of thermally conductive pathways immersed in a catalyst matrix. The systematic design of such layouts requires appropriate formulations of heat management metrics, as well as advanced design tools that assimilate manufacturing constraints. Due to these challenging requirements, conventional reactor designs have not addressed these complex engineering problems.

In various aspects, the systematic design optimization approach described herein finds the spatial arrangement of optimal fin inserts encompassing a catalyst matrix by formulating the optimization problem such that the heat generated in the systems is maximized while keeping the maximum temperature under a threshold.

Manufacturability constraints considered include limiting the minimum length scale of optimized designs and explicitly enforcing catalyst or fin insert material in regions of the design. The optimization approach is used to study the effect of the number and the spatial arrangement of the fin inserts and operating temperatures on the performance of the system.

Fin inserts as described herein may comprise any material, depending on the intended application of the reactor comprising the fin inserts, as would be determinable by one having ordinary skill in the art. Metals are preferred due to their relatively higher coefficients of thermal conductivity, workability (e.g., extrudability), etc. For example, Fischer-Tropsch reactors may utilize aluminum fin inserts, in at least some approaches. Other approaches may utilize ceramics, etc.

Various aspects of the present disclosure describe fin insert designs used for thermo-catalytic reactions which occur in various classes of energy systems, including Fischer-Tropsch reactors. These optimal fin inserts provide additional thermally conductive pathways in a catalyst matrix to achieve better heat management, thereby increasing performance. Two-dimensional layouts were obtained using a systematic design optimization tool that realizes designs via a fictitious density field. The physical analysis of the system was computed using information comprising response functions derived from experimental data, geometry of design domain, manufacturability, operating temperature constraints, etc. The two-dimensional layouts of the fin inserts may encompass a catalyst matrix and be encased by tubular pipe (e.g., a steel pipe), in at least some approaches.

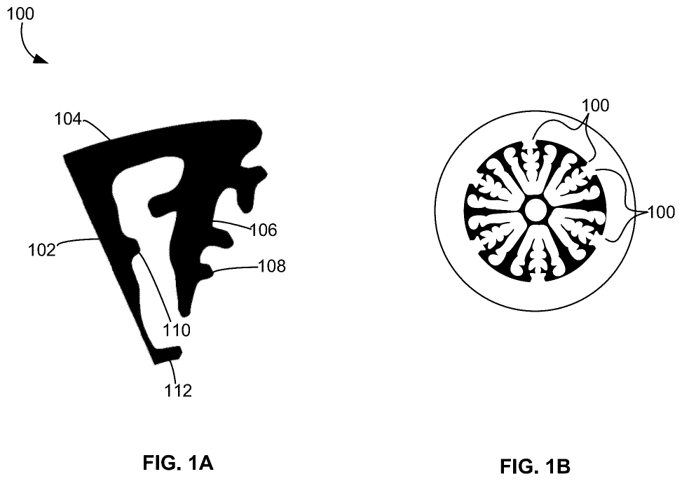

FIG. 1A depicts an optimized design of one-half of a fin 100 in accordance with one aspect of the present invention. As an option, the present fin 100 may be implemented in conjunction with features from any other approaches listed herein, such as those described with reference to the other FIGS. Of course, however, such a fin 100 and others presented herein may be used in various applications and/or in permutations which may or may not be specifically described in the illustrative approaches listed herein. Further, the fin 100 presented herein may be used in any desired environment.

FIG. 1A depicts an optimized design of one-half of a fin 100 having a cross member 102 and an outer portion 104 extending laterally from a distal end of the cross member 102. As shown, the outer portion 104 comprises branches 106 extending from an inner surface thereof. Each branch includes protrusions 108 extending therefrom. The cross member 102 additionally comprises a relatively short extension 110 centrally located along the cross member 102. A portion of the center portion 112 is also shown.

FIG. 1B depicts an optimized design including the fin 100 shown in FIG. 1A. As an option, the present fin 100 may be implemented in conjunction with features from any other approaches listed herein, such as those described with reference to the other FIGS. Of course, however, such a fin 100 and others presented herein may be used in various applications and/or in permutations which may or may not be specifically described in the illustrative approaches listed herein. Further, the fin 100 presented herein may be used in any desired environment.

As shown, the portion of the fin 100 shown in FIG. 1A is reflected to form a complete fin 100. Fin 100 is replicated around the center portion of the insert. The insert includes six fins 100 in this exemplary aspect. The shown measurements are provided by way of example only and should not be interpreted as limiting.

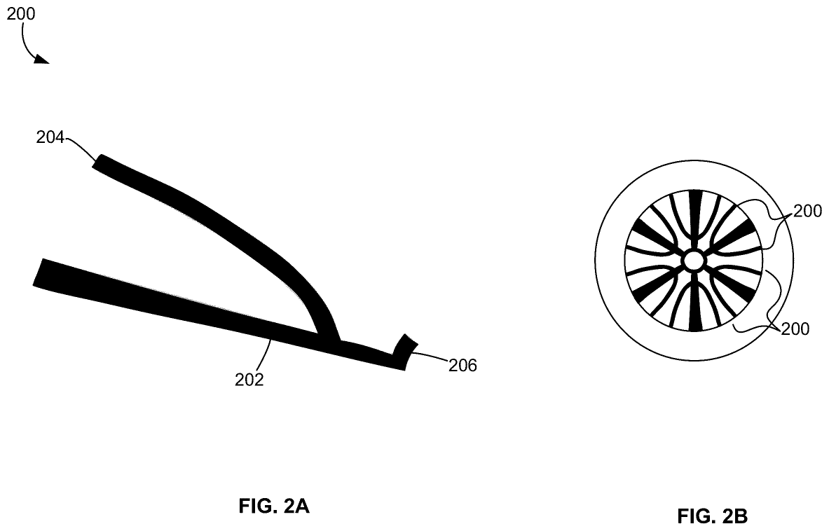

FIG. 2A depicts an optimized design of one-half of a fin 200, in accordance with one aspect of the present invention. As an option, the present fin 200 may be implemented in conjunction with features from any other approach listed herein, such as those described with reference to the other FIGS. Of course, however, such a fin 200 and others presented herein may be used in various applications and/or in permutations which may or may not be specifically described in the illustrative approaches listed herein. Further, the fin 200 presented herein may be used in any desired environment.

As shown, the cross member 202 comprises a relatively long extension 204 extending from an inner surface thereof. A portion of the center portion 206 is also shown.

FIG. 2B depicts an optimized design including the fin 200 shown in FIG. 2A. As shown in FIG. 2B, the portion of the fin 200 shown in FIG. 2A is reflected to form a complete fin 200. Fin 200 is replicated around the center portion of the insert. The insert includes six fins 200 in this exemplary aspect.

FIG. 2C depicts an optimized design including the fin 200 shown in FIGS. 2A-2B, in accordance with one approach. The optimized configuration of FIG. 2C uses a simplified design approach with restricted freedom in shape changes. As shown, the center portion design enables the center portion to be resiliently deformable. The notch along the center portion is configured to enable the center portion to reversibly compress for temporarily reducing a circumference of the insert.

A cross section (e.g., cross sectional profile) as used herein refers to the cross section along plane which is perpendicular to the longitudinal axis of the product, the insert, the insert in combination with a reactor tube, etc., and the view of said cross section is taken along the longitudinal axis.

A product, according to various aspects of the present disclosure, may include a heat conducting insert for a reactor. In various aspects, the insert preferably comprises an elongated center portion and at least one cross member extending outwardly from the center portion. The insert comprises an outer portion extending laterally from a distal end of the cross member. In preferred aspects, the center portion, the cross member, and the outer portion are part of a monolithic, extruded structure, and may be formed by a conventional extrusion process. The monolithic, extruded structure preferably has physical characteristics of extrusion. Physical characteristics of extrusion may include the structure having no seams between the portions/cross member(s), a consistent cross-sectional profile along the longitudinal axis thereof, substantially smooth surface finish (e.g., thereby minimizing post-processing machining), elongated grain structure in the direction of the material, etc.

In at least some aspects, at least a portion of the center portion (e.g., a partial circumference of the center portion), the cross member, and at least a portion of the outer portion are collectively referred to as a “fin” of the insert and/or a “fin insert.”

In various approaches, the insert includes a plurality of cross members extending outwardly from the center portion. In at least some exemplary aspects, the plurality of cross members extending outwardly from the center portion are analogous to a hub and spoke design, as would become apparent to one having ordinary skill in the art.

In some aspects, the insert includes a plurality of cross members extending outwardly from a common center portion in a symmetrical manner. For example, the cross members may have substantially the same cross sectional profile (e.g., a cross sectional profile of the cross member is repeated for each cross member in the plurality of cross members). Similarly, the design of a fin comprising at least a portion of the center portion, the cross member, and at least a portion of the outer portion may be repeated around a singular (e.g., imaginary) center point to obtain a design for an insert having a complete center portion (e.g., there are no gaps in the center portion).

In another exemplary aspect, a first cross member may have a reflected cross sectional profile of the cross member positioned adjacent thereto (e.g., a second cross member having the reflected cross sectional profile of the first cross member). The plurality of cross members may alternate between the cross sectional profile of the first cross member and the cross sectional profile of the second cross member. Similarly, the design of a fin comprising at least a portion of the center portion, the cross member, and at least a portion of the outer portion may be reflected in the design. For example, the original fin design in combination with the reflected fin design may form a pair. The pair of fins may be repeated around a singular (e.g., imaginary) center point to obtain a design for an insert having a complete center portion (e.g., there are no gaps in the center portion) such as those shown in FIGS. 1B and 2B.

In at least some approaches, the heat conducting insert comprises an outer portion extending laterally from a distal end of the cross member. The distal end of the cross member is preferably at the opposite end (e.g., a proximal end) of the cross member which is coupled to the center portion. In preferred aspects, the outer portion does not form a continuous perimeter. For example, the insert does not have continuous contact with an imaginary perimeter surrounding the insert. According to some approaches, the imaginary perimeter may be defined by an interior circumference of a reactor tube in which the insert is inserted (e.g., press-fitted). In other aspects, the outer portion forms a continuous perimeter.

In one aspect, a width of the cross member increases therealong from the proximal end thereof toward the distal end thereof. For example, the width of the cross member may taper along the length of the cross member extending from the outer portion toward the center portion. In an alternative aspect, a width of the cross member decreases therealong from the proximal end thereof toward the distal end thereof. In yet further aspects, the width of the cross member may fluctuate therealong from the proximal end thereof toward the distal end thereof. For example, the cross member may appear to be hourglass shaped in some instances.

In at least some aspects, the center portion is resiliently deformable. For example, the center portion is configured to reversibly compress for temporarily reducing a circumference of the insert. The center portion preferably reversibly compresses to enable the insert to be press-fitted into a reactor shell (e.g., a reactor tube). In various aspects, the center portion is continuous along a longitudinal length thereof. A continuous center portion refers to the center portion not being broken and/or capable of serving as a feed pipe for the reactor, as would become apparent to one having ordinary skill in the art upon reading the present disclosure. In other aspects, the center portion is not continuous along a longitudinal length thereof.

According to some aspects, the outer portion has branches extending from an inner surface thereof toward the center portion. The branches have protrusions extending outwardly therefrom. In at least some aspects, the branches have characteristics of tree generation according to various techniques known in the art.

In at least one aspect, the cross member has extensions extending outwardly from the cross member to the inner surface thereof toward the center portion. Extensions on the cross member may extend outwardly therefrom and have characteristics of tree generation.

In at least some approaches, the mass distribution of the insert (e.g., the fin) may be more concentrated (e.g., higher) around the center portion relative to the outer perimeter of the insert.

A reactor, according to at least some aspects described herein, includes a shell (e.g., a reactor tube) and an insert as described in detail above. Dimensions for the diameter of the insert, the shell, the shell in combination with the insert, etc., would be determinable by one having ordinary skill in the art in view of the type of reactor used and/or the intended application. For example, the diameter of the inner center portion may be in a range of about 6.35 mm to about 9.5 mm in some applications. For at least some of the exemplary aspects described herein, a 4″ schedule XXH pipe (4.5″ OD, 3.152″ ID) was used.

### Experimental: Design and Background Information

The optimization problem formulation as described herein maximizes the heat generated in the system (e.g., as a proxy for fuel production) while keeping the maximum temperature under a threshold. In various approaches, the highly exothermic, temperature-dependent reactions in the fuel system of Fischer-Tropsch reactors were simulated using a heat transfer model with an Arrhenius temperature dependence in the volumetric heat generation field. In various approaches, a two-dimensional setup is preferred since the reactor inserts are produced through extrusion. Numerical stability of the system was achieved by adding a smooth Heaviside function to the heat generation expression, which is not typically used in benchmark optimization problems. Material properties and nonlinear behavior of the system were characterized from experimental data. The thermal response was predicted using the finite volumes in an open-source software (e.g., OpenFoam®) and the geometry was realized through density-based topology optimization, namely, the solid isotropic material with penalization method using in-house systematic design codes (e.g., LiDO). Manufacturability constraints were included by limiting the minimum length scale of the converged designs and restricting regions of the design domain. Studies on the number and spatial arrangement of fin inserts and operating temperatures were performed.

Simplified optimization approaches of FT reactors typically generate suboptimal designs due to a relatively narrow design space available to explore. Despite their simplicity, these extrudable inserts were placed inside a reactor tube and tested successfully using both iron and cobalt catalyst materials. The first of its kind reactor worked well for catalysts of moderate activity, which motivated the application of more advanced design approaches to this problem.

There exists a need of a systematic optimization approach to explore a wider design space and for further improvement in performance. However, limitations of commercially available computational analysis and design tools restrict the application of systematic design approaches. Advanced design tools typically require complex derivations associated with both the optimization problem formulation and the mathematical model used to predict the system's response, even when the physics are approximated by a thermal continuum model. In the former, thermal management through enforcing temperature constraints can be formulated in multiple ways, and studies concerning stability of the optimization problem are required. With respect to the latter, the model should capture the complex chemical reactions that transform gas into fuel.

Various aspects of the present disclosure use state-of-the-art computational analysis and design tools to generate the two-dimensional layout of fin inserts in next generation, modular FT reactors. A diffusion model predicts the thermal response, and the complex chemical phenomena occurring in the catalyst are represented by a nonlinear heat source term. The design approach employed relies on a fictitious density field to realize optimal designs. This continuous field is characterized by blurry interfaces and thus, inexact geometry representation by construction. The effect of this inherent fuzziness in both the analysis of the response and extraction of optimal designs is assessed by verifying the performance of the optimal designs against a commercial software.

At least some of the modular FT reactors described herein are composed of concentric steel tubes that encapsulate the FT reaction catalyst (e.g., iron/cobalt). Feed syngas flows into the tube and through the fixed catalyst bed where it is polymerized into higher value products. An external tube contains saturated steam to control reactor temperature. Highly thermally conductive metallic fin inserts are incorporated for enhancing thermal management of this highly exothermic reaction, as thermal control controls product distribution and reactor stability. To maximize the productivity of the reactors and minimize costs, the insert should contain as little material as possible while still providing sufficient heat conduction from the catalyst to the walls of the inner tube. The inserted fins yield thermal conduction pathways, but any material occupied by fin excludes catalyst. Conversely, the low conductivity catalyst ultimately leads to large thermal gradients and lower efficiency reactors. Thus, the central design problem is to determine the fin layout which strikes an optimal balance between these inherently adversarial requirements.

### Experimental: Reactor Design Problem

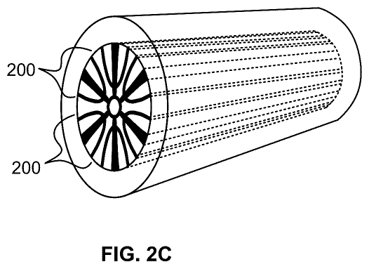

FIG. 3 includes a representation of a problem domain separating the design subdomain 302 and non-design subdomain 304. The FT reactor problem is discretized on a two-dimensional wedge domain. By taking advantage of symmetry conditions, only a portion of the FT reactor is modeled based on the number of prescribed fin inserts. Here, the wedge angle θ is defined as half of the angle between two consecutive fins. The wedge angle θ of the sector controls the angular symmetry of the design and thus the ultimate number of fins. The angle between two consecutive fins is defined as 2θ. The wedge is subdivided into three phases to model the stainless steel circular tube, the aluminum fin insert, and the iron/cobalt catalyst (e.g., pellets) comprising the porous fixed-bed reactor. The central goal of the optimization techniques described herein is to determine the optimal spatial arrangement of aluminum and porous material in the non-design subdomain 304. Hence, only the design subdomain 302 is optimized. The tube geometry remains unchanged, and the exterior of this wedge domain is assumed to contact the saturated steam as described in detail above.

### Design Optimization Approach

The design is optimized using density-based topology optimization, namely the Solid Isotropic Material with Penalization (SIMP). In this method, material properties are penalized by a continuous fictitious density field denoted by γ, which is bounded between 0.0 and 1.0. The aluminum fin corresponds to regions with γ=1.0 while the porous region corresponds to γ=0.0. This field evolves throughout the optimization process to converge into a realizable design, which is constructed using the three-field strategy. These three fields correspond to: the raw fictitious density field, the filtered density field, and the filtered projected density field.

In the three-field approach, a set of design variables, \hat{γ}, also bounded between 0.0 and 1.0, are used to construct γ through filtering and projection. First, the filtering operation is perform using a Helmholtz filter, i.e., by solving the following equation subject to homogeneous Neumann boundary conditions:

$$- {ρ}^{2} {∇}^{2} \tilde{γ} + \tilde{γ} = \hat{γ} , \qquad ( 1 )$$

where ρ represents the filter radius and controls the minimum allowed length scale of the filtered density field, \hat{γ}. Second, \hat{γ} is projected using a smoothed Heaviside function:

$$γ = 0.5 + 0.5 \frac{tanh ( ζ ( \tilde{γ} - 1. ) )}{tanh ( ζ )} , \qquad ( 2 )$$

with ζ controlling the projection sharpness. This third (filtered, projected) fictitious density field, herein defined as the design field, γ, is used to parameterize the physical problem and enable topology optimization as described in detail below.

The inner tube is modeled as part of the physical problem, but it is not designed. Hence, the design field is not defined in FIG. 3. The goal of the optimization is to determine the spatial arrangement of fin inserts (γ=1.0) and the catalyst (γ=0.0) in the design subdomain.

### Physical Model

A steady heat diffusion model is employed to model the thermal response of the reactor wedge and determine the temperature field, T:

$$\frac{\partial }{\partial {x}_{i}} ( κ ( γ ) \frac{\partial T}{\partial {x}_{i}} ) + G ( γ , T ) = 0 , \qquad ( 3 )$$

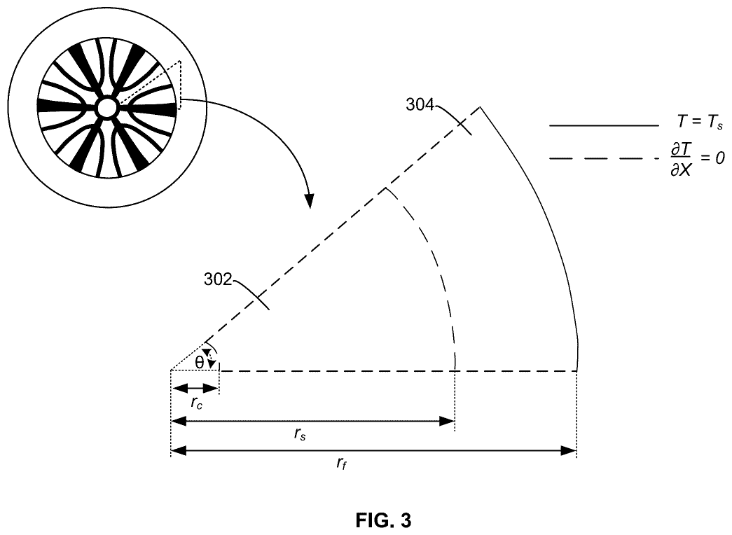

In this boundary value problem, a constant temperature, Tₛ, is prescribed along the outer surface of the inner tube in contact with saturated steam. Adiabatic conditions are prescribed along the three remaining boundaries, [symbol] ·∇T=0 with n being the outward facing normal to the boundary. The bulk material properties for each phase and boundary conditions are specified in FIG. 4. The outer boundary of the wedge corresponds to the interface between the reactor and an external cooling channel. The latter is not included in the model, as instead it is assumed that the external temperature is prescribed. The outer surface of the tube is set to Tₛ=485 K, unless specified otherwise.

The physical parameters are functions of the design variable (or constant in the case of the tube) and thus, the design variables control which material is being modeled. In Eq. 3, the thermal conductivity is denoted by κ, and is defined as:

$$κ ( γ ) = \{ \begin{matrix}{κ}_{tb} , & ∀ r > {r}_{s} , \\ {κ}_{i n} + ( 1 - {γ}^{β} ) ( {κ}_{c a} - {κ}_{i n} ) , & ∀ r \leq {r}_{s} ,\end{matrix} \qquad ( 4 )$$

Here, [κ_{tb}, κᵢₙ, κ_{ca}] are the bulk material properties for the tube, inserts, and catalyst phases, respectively, and β represents the penalization on intermediate densities. Note that when γ=0.0, the thermal conductivity is equal to the conductivity of the porous material, κ_{ca}. Conversely, when γ=1.0, the conductivity corresponds to the conductivity of the thermal insert, κᵢₙ.

This equation thus provides a smooth interpolation between the two phases. The temperature-dependent heat source term, G, is defined as follows:

$$G ( γ , T ) = \{ \begin{matrix}0 , & ∀ r > {r}_{s} , \\ ( 1 - γ ) \overline{G} ( T ) , & ∀ r \leq {r}_{s} ,\end{matrix} \qquad ( 5 )$$

and thus, linearly interpolates between the aluminum fin, where G=0.0 and no heat is generated, and the porous region, where G=G̅ defined below.

### Heat Generation in the Catalyst

The FT chemistry of the tubular reactors considered in this manuscript consists of the following chemical reactions:

CO+H₂O⇄CO₂+H₂

CO+3H₂→CH₄+H₂O

CO+2H₂→(1/n)(CₙH₂ₙ)+H₂O

2CO→C+CO₂ (6)

The first reaction represents the water-gas shift reaction, the second row

shows the methanation reaction (i.e., the conversion of carbon monoxide to methane), the third corresponds to the synthesis of C₂+hydrocarbons, and the final row is the Boudouard reaction.

A temperature-dependent exponential heat source term is used to approximate the exotherm of the FT reaction, instead of incorporating Eqs. 6, all products were lumped together and only the consumption of CO in the catalyst is considered. The thermal heat source was defined such that approximately 2.4 liters of fuel per day are produced for every liter of catalyst available. An average heat of reaction of 165 KJ/mol reactive per liter of catalyst was used to obtain an equivalent heat generation of 337 W per liter of catalyst. This resulted in the representative values in the temperature-dependent Arrhenius expression for heat generation in the catalyst subdomain, G_{ca}, in the table of FIG. 4.

To avoid numerical instability, the maximum allowed heat generation for the catalyst is kept constant if the temperature exceeds a threshold T_{G}_{_{ca}}^{max}. A smooth Heaviside function similar to the expression used in Eq. 2 is used here:

$${\overline{G}}_{c a} ( T ) = {G}_{c a} ( T ) + ( {G}_{c a} ( {T}_{{G}_{c a}}^{max} ) - {G}_{c a} ( T ) ) ( 0 \text{.5} + 0.5 \frac{tanh ( ζ ( T / {T}_{{G}_{c a}}^{{max}^{- 1.}} ) )}{tanh ( ζ )} ) . \qquad ( 7 )$$

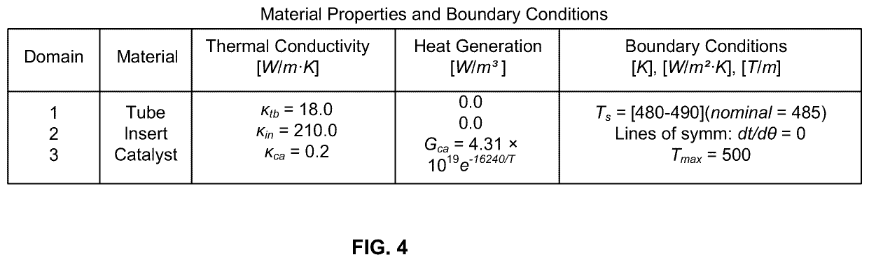

The projection sharpness, ζ, is typically set to a value high enough such that the desired limit of the heat source is enforced (i.e., (ζ=[0.1-100]), see the table shown in FIG. 5. Note that this augmented expression is intended to stabilize the computations associated with the solution of the physical analysis but does not compromise accuracy of response so long as T_{G}_{_{ca}}^{max}. In this work, this temperature limit is set to T_{G}_{_{ca}}^{max}=502.5 K.

### Optimization Problem Formulation

The optimization problem includes maximizing the reaction rate in the catalyst, or equivalently the heat generated by the reaction, without exceeding a prescribed maximum temperature. This serves as a proxy for maximizing fuel production while preventing autothermal runaway. The formulation reads:

$${max J}_{γ} = 1 / C \int G ( γ , T ) dV s . t . {g}_{T} = {( \frac{\int {( T / {T}_{ref} )}^{n} d V}{\int d V} )}^{1 {/}_{n}} - 1 \leq 0 , \qquad ( 8 )$$

where the normalization parameter of the objective is C=∫ G(γ₀,T) dV, with γ₀ being the initial design. The exponent n controls the sharpness of the smoothed maximum temperature measure, i.e.,

$${T}_{max} \approx {( \frac{\int {T}^{n} d V}{\int d V} )}^{1 {/}_{n}} ,$$

see the table of FIG. 5. For large values of n, this constraint tends to T≤T_{ref} and ensures that the temperature does not exceed the reference temperature anywhere in the computational domain. In addition, T_{ref} represents an indirect measure of the maximum allowed temperature. Note this constraint is such that the maximum temperature anywhere in the system is below T_{ref}<T_{G}_{_{ca}}^{max}. Hence, as long as the constraint is satisfied, the heat generated by the heat source will follow the exponential expression for the catalyst, G_{ca}, see the table in FIG. 4. This circumvents any inaccuracies resulting from the threshold expression in Eq. 7 since solutions to the optimization problem stay below the maximum threshold.

Nonlinear programming is employed to update the design and to find optimal layouts for fin inserts. In this gradient-based optimization approach, derivatives of objective and constraint functionals with respect to the design variables are computed using the continuous adjoint method. The optimization problem is solved using the method of moving asymptotes with its standard parameter setting.

### Fabrication Restrictions and Initializations

The geometry was adapted to reflect a design problem subject to symmetry, i.e., θ=180/n_{fins} with n_{fins} being the number of fins. In addition, the vicinity of the external boundary of the design subdomain is assigned fixed design variable to enforce either fin insert or catalyst by construct in such regions.

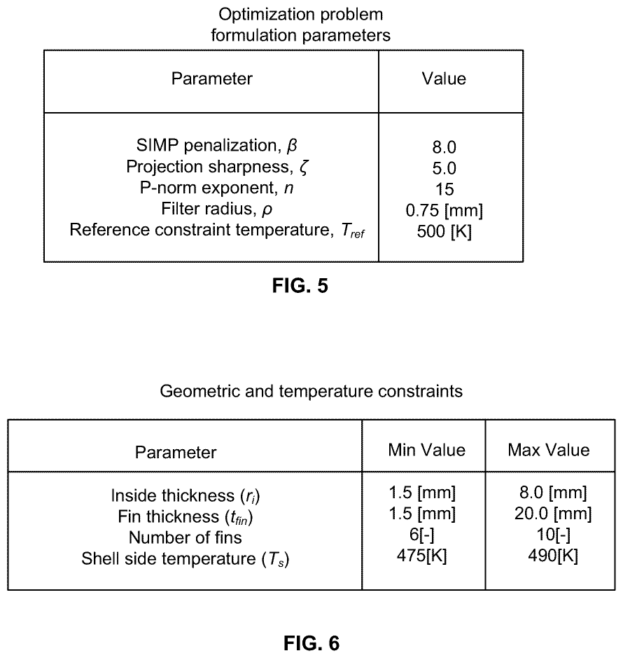

The thickness of this prescribed region along this subdomain is given by the minimum manufacturable feature, t_{fin}, provided in the table shown in FIG. 6. Note that the thickness of the inclined and horizontal boundaries is half of the manufacturability constraint since symmetry is considered across fin inserts. This problem initialization is sufficient to avoid disconnected inserts due to the relatively simple and small design space and because the physics promote continuous designs, i.e., disconnected pieces cannot channel heat to the boundaries, The remaining design field is initialized with a fictious density of 0.5, and changes throughout the optimization process. Optimal designs are further characterized by a minimum manufacturable feature of at least twice the provided filter radius, ρ, in Eq. 3, satisfying the guidelines in the table of FIG. 6.

### Numerical Solution

The physical response of the system is approximated using OpenFoam® via the finite volume method. The nonlinear governing equation is solved by first linearizing the source term. Then, the linearized source term is solved using Geometric Agglomerated Algebraic Multigrid (GAMG) solver with Gauss-Seidel smoother. The linearized source term is updated at each outer loop iteration and iteration continues until convergence under a threshold ϵ<1×10⁻⁷. Note, however, that the findings do not rely on any discretization technique. Alternative numerical methods such as the finite element method, or finite element-based advanced methods, may be used instead without loss of generality.

Designs are realized by a continuous design field. Thus, intermediate densities in the interfaces (i.e., between the catalyst and insert phases) are unavoidable. To quantify inaccuracies in the geometry description, stereolithography (STL) files of the designs are obtained from the design field, γ, by applying a filter that generates an isocontour at γ=0.5. These STL are surface representation files which contain defined boundaries between the fitted meshes and porous catalyst material. They are used an input for body-fitted meshes into a commercial software, i.e., Star-CCM+ (Siemens), to verify their performance using the same material properties and problem setup described herein.

### Experimental: Reactor Design via Density-Based Topology Optimization

The topology optimization algorithm described above is employed to design FT reactor inserts as a function of the number of fins and the operating temperature.

The fin insert topology generated by the optimization framework reveals an organic structure that concentrations fin material near the inner tube wall and develops into thick branches that travels back to the center of the reactor. The formulation employed imposes a hierarchy of length scales as the large branches further subdivide into numerous thinner branches, Note that the minimum length scale observed is in agreement with the enforced value from the Helmholtz filter. The optimal design also contains a tapering angle leading to thinning of the main branches as they approach the center of the reactor. Importantly, these features are generated automatically and area revealing high performance architecture from non-intuitive portions of the design space.

Varying the Number of fins

The formulation of the design problem imposes angular symmetry over a predetermined sector. Equivalently, this imposes a fixed number of fins that fully span from the center of the reactor to the inner tube wall. The impact of this manufacturing constraint on the optimized designs is investigated for n_{fins}=[3, 4, 5, 6, 8, 10].

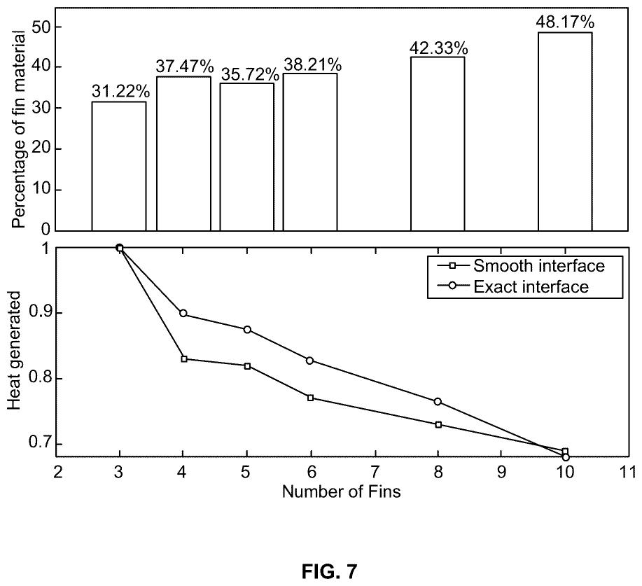

For post-processed optimal designs, the intermediate region has been eliminated by choosing the γ=0.5 and projecting all other values to their closest extremum. In all designs, the fin thickness increases radially, again generating tapered inserts, and generally concentrate the insert material towards the outer circumference of the design domain. The complexity of the fin topologies is considerably reduced for a large numbers of fins. The fins also become thinner as more fins are included. For a large numbers of fins, more inserted fin material is used to satisfy the temperature constraint. Similar fin insert material is used for configurations up to six fins, but significantly more material is used for ten fins. This is counterintuitive and surprising as the additional fins would be expected to further enhance heat transfer. Instead, it appears that including more fins leads to a smaller design domain for the algorithm (i.e., a smaller designable sector) and less opportunity for branching. Indeed, the branching increases dramatically as the number of fins decreases and suggests that hierarchy of scales manages temperature while minimizing material usage. The reactor performance is maximized when the volumetric reaction rate, and hence heat generation, are maximized. This objective function decreases with the number of fins used in the reactor. This is as expected, as the more space devoted to cooling the reactor, the less room there is for the porous catalyst bed driving the reaction. The decay in performance is again attributable to the reduced design freedom from externally imposing architecture via the manufacturing constraint of fin number. Having more fins leads to a reduction in the designable space. Interestingly, using larger numbers of fins more closely resembles conventional architectures, but it is by allowing the algorithm the large latitude to create the designs that the performance is maximized. Alternatively, if large fin numbers are used due to other engineering constraint, e.g., structural integrity, the optimization algorithm still provides a pathway to improve performance. A diminished performance of optimal designs, however, is the expected trade-off to better structural integrity. In the absence of any structural constraint, the reactor includes at least three fins as this maximizes productivity while minimizing fin insert material usage, see FIG. 7 comparing the associated performance values for designs having varying numbers of fins and fin material usage.

### Varying the Operating Temperature

In the modular FT reactors considered, the tube wall temperature, Tₛ, is controlled by adjusting the operating pressure of the saturated steam serving as the coolant on the external surface of the reactor. The nominal temperature, Tₛ=485 K, was used. Nevertheless, during practical operation, this temperature may be adjusted and serves as a process control parameter. To assess the effect of varying this prescribed temperature on the optimal topology and its performance, the high highest performing fin number from the previous section is chosen, n_{fins}=3, and several different surface temperatures are investigated, Tₛ=[480.0 K, 482.5 K, 485.0 K, 487.5 K, 490.0 K]. All other parameters, including the target maximal temperature, T_{ref}=500 K, are unchanged.

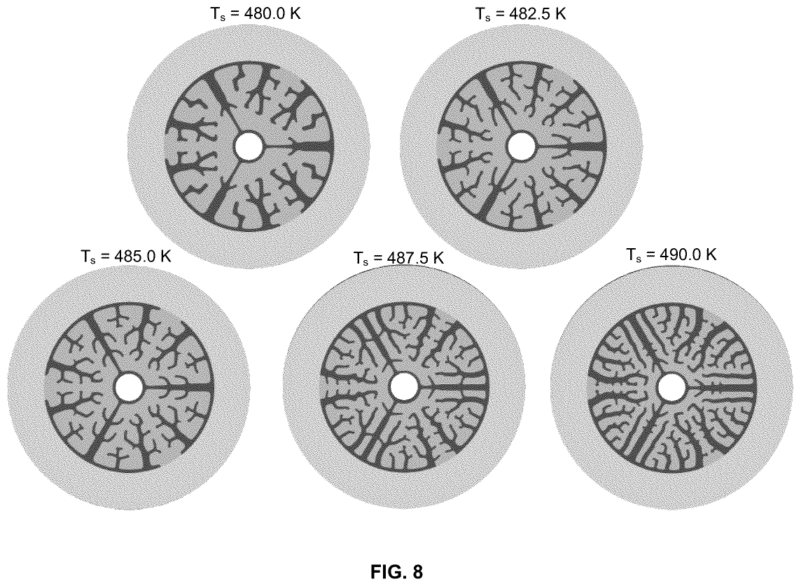

FIG. 8 includes the reactor optimal designs for each prescribed temperature. Because of the diminished conduction driving force, more intricate topologies and fin insert material are used as Tₛ increases. The salient features observed earlier persist, as the fins are still hierarchical and taper toward the center of the reactor.

Less conductive fin insert material may be used for the lower external temperatures, this leads to a drop in reactor performance. For Tₛ<485 K, the optimal designs show significantly lower heat generation. Alternatively, for Tₛ>485 K, the topologies of the optimal inserts use progressively more material. These studies suggest that using the optimal design with a three-fin configuration and operation temperature of Tₛ=485 K provides an appropriate balance between performance and material usage.

### Experimental: Conclusions

Optimal designs of modular Fischer-Tropsch reactors were obtained via a systematic design approach that automatically determines the spatial arrangement of highly conductive fin inserts for improved thermal management. A density-based topology optimization algorithm was developed to determine the optimal material layout of the fins within the catalyst matrix for the two-dimensional reactor cross section. The temperature profiles in the reactor were simulated using a simplified but industrially relevant model for heat generation in the fixed porous catalyst bed. This simulation was used to formulate and solve an optimization problem to determine fin architectures which maximize reactor productivity while preventing autothermal runaway. Additionally, several strategies for improving manufacturability of the computer-generated designs were presented. In contrast to traditional trial-and-error methods characterized by expensive iteration, the computer-driven approach presented herein automates and accelerate the design process. This change in paradigm reveals a systematic methodology that has not previously been explored in the design of fin inserts for FT reactors. Further, the presented studies demonstrated how architectural and processing parameters, such as fin number or operating temperatures, can be incorporated into the design process. The design tools thus play an important role in enhancing exploration of the design space and informing designers of the influence of relevant features that can lead to improved performance. Indeed, this work suggests the importance of hierarchy and fin tapering as important strategies for improving thermal management. These advances are helping to engineer the next generation of modular FT reactor, addressing variable scales of syngas production and ensuring pervasive deployment regardless of site size.

### In Use

Various aspects of the present disclosure improve upon the performance of tubular Fischer-Tropsch reactors. At least some of the aspects as described herein may be used with thermo-catalytic reactors, as would become apparent to one having ordinary skill in the art upon reading the present disclosure. In other approaches, at least some aspects as described herein may be used with other porous reactors.

The inventive concepts disclosed herein have been presented by way of example to illustrate the myriad features thereof in a plurality of illustrative scenarios, aspects, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of the present invention have been described above, it should be understood that they have been presented by way of example only, and not limitation. Thus, the breadth and scope of an aspect of the present invention should not be limited by any of the above-described exemplary approaches, but should be defined only in accordance with the following claims and their equivalents.

What is claimed is:

1. A heat conducting insert for a reactor, the insert comprising:
an elongated center portion;
a cross member extending outwardly from the center portion; and
an outer portion extending laterally from a distal end of the cross member.

2. The insert of claim 1, wherein the center portion, the cross member and the outer portion are part of a monolithic, extruded structure.

3. The insert of claim 1, wherein a width of the cross member increases therealong from a proximal end thereof toward the distal end thereof.

4. The insert of claim 1, wherein a width of the cross member decreases therealong from a proximal end thereof toward the distal end thereof.

5. The insert of claim 1, wherein the center portion is resiliently deformable, wherein the center portion is configured to reversibly compress for reducing a circumference of the insert.

6. The insert of claim 1, wherein the center portion is continuous along a longitudinal length thereof.

7. The insert of claim 1, wherein the center portion is not continuous along a longitudinal length thereof.

8. The insert of claim 1, wherein the outer portion has branches extending from an inner surface thereof toward the center portion.

9. The insert of claim 8, wherein the branches have protrusions extending outwardly therefrom.

10. The insert of claim 1, wherein the cross member has extensions extending outwardly therefrom.

11. The insert of claim 1, wherein a plurality of cross members extend outwardly from the center portion in a symmetrical manner, each cross member having a respecting outer portion extending therefrom.

12. The insert of claim 11, wherein the cross members have substantially the same cross sectional profile.

13. The insert of claim 1, wherein the outer portion does not form a continuous perimeter.

14. The insert of claim 1, wherein a mass distribution of the insert is concentrated around the center portion.

15. A reactor, comprising:
a shell; and
an insert in the shell, the insert comprising:
an elongated center portion,
a cross member extending outwardly from the center portion, and
an outer portion extending laterally from a distal end of the cross member.

16. The reactor of claim 15, wherein the insert is press-fitted into the shell.

17. The reactor of claim 15, wherein the insert encompasses a catalyst matrix.

18. The reactor of claim 17, wherein the shell encompasses the insert and the catalyst matrix.

19. The reactor of claim 15, wherein the insert is heat conducting.

20. The reactor of claim 15, wherein the insert comprises aluminum.
